(19) United States
(12) Patent Application Publication
(10) Pub. No.: US 2024/0162444 A1
(43) Pub. Date: May 16, 2024

(54) ELECTRODE FOR SECONDARY BATTERY, METHOD OF MANUFACTURING THE SAME AND SECONDARY BATTERY COMPRISING THE SAME

(71) Applicant: LG Energy Solution, Ltd., Seoul (KR)

(72) Inventors: Myeongsoo Kim, Daejeon (KR); Ki Tae Kim, Daejeon (KR); Jeonggil Kim, Daejeon (KR); Taegon Kim, Daejeon (KR)

(21) Appl. No.: 18/281,765

(22) PCT Filed: Jul. 18, 2022
(86) PCT No.: PCT/KR2022/010468

§ 371 Date: Sep. 12, 2023

(30) Foreign Application Priority Data
Jul. 30, 2021 (KR) 10-2021-0100746

(51) Int. Cl. H01M 4/62; H01M 4/04; H01M 10/052; H01M 4/02

(52) U.S. Cl. CPC H01M 4/623; H01M 4/0433; H01M 4/0471; H01M 4/624; H01M 10/052; H01M 2004/021

(57) ABSTRACT

An electrode for a secondary battery, a method of manufacturing the same, and a secondary battery comprising the same are provided. The electrode includes a dry electrode film comprising an active material having an average particle diameter of 0.05 μm to 3 μm, an electrically conductive material, and a fibrillated binder; and a current collector on which the electrode film is stacked.

### CROSS REFERENCE WITH RELATED APPLICATION(S)

This application is a National Stage Application of International Application No. PCT/KR2022/010468, filed on Jul. 18, 2022, which claims the benefit of priority based on Korean Patent Application No. 10-2021-0100746 filed on Jul. 30, 2021, the disclosures of which are incorporated herein by reference in their entirety.

### FIELD OF DISCLOSURE

The present disclosure relates to an electrode for a secondary battery, method of manufacturing the same, and a secondary battery comprising the same.

### BACKGROUND

Recently, there is increasing interest in energy storage technology. As the application area thereof extends to the energy for mobile phones, camcorders, notebook PCs, and even electric vehicles, the effort of research and development of electrochemical devices is being carried out more and more concretely.

Electrochemical devices are the most noteworthy area in this respect, and among them, the development of a secondary battery capable of charging/discharging is the focus of attention. Recently, in developing these batteries, research and development on the design of new electrodes and batteries are being actively carried out in order to improve capacity density and specific energy.

Among secondary batteries that are currently put to practical use, lithium secondary batteries are in the spotlight because of their high operating voltage and significantly higher energy density compared to conventional batteries.

Meanwhile, along with the expansion or development of usage of secondary batteries, there is a continuous need for improvement in the electrode in terms of low resistance, high capacity, and improvement of mechanical properties and productivity.

The electrode for the secondary battery is generally manufactured by stacking an electrode active material layer, which is formed by binding an active material and an electrically conductive material used as necessary with a binder, on a current collector. Specifically, a method of applying a slurry containing an electrode active material, a binder, an electrically conductive material, etc. on a current collector and removing the solvent by heat or the like is generally used. However, the method described above has a disadvantage that the solvent must be removed from the slurry for the electrode, and thus economic feasibility and productivity are lowered.

Therefore, in order to improve this disadvantage, a method for manufacturing an electrode without using the slurry for the electrode has been proposed. That is, a technique for manufacturing an electrode film by mixing an active material, a binder, and an electrically conductive material without a liquid medium such as a solvent or a dispersion medium, and then passing the powder mixture through a rolling roll is being actively developed. Generally, binders called “fibrillizable binders” or fibril-forming binders are used in these methods. The binder makes it possible to produce a free-standing electrode film by binding the active material and the electrically conductive material while being fibrillated. The electrode film prepared in this way is used for manufacturing the electrode in a manner of stacking it on the current collector.

The conventional method as described above provides various advantages compared to the method of applying the slurry for the electrode. However, the method has a disadvantage that when the particle size of the active material is small, since the dough becomes very hard, it is difficult to subsequent processing, and it is well broken due to lack of flexibility.

Therefore, a solution to this problem is required.

### PRIOR ART DOCUMENT

Korean Laid-open Patent Publication No. 10-2006-0025230

### SUMMARY

It is an object of the present disclosure to provide an electrode for a secondary battery comprising a dry electrode film having excellent flexibility and minimizing breakage while comprising an active material having a small particle size, which has been devised to solve the above problems of the prior art.

It is another object of the present disclosure is to provide a method for manufacturing an electrode for a secondary battery capable of efficiently manufacturing the electrode.

It is still another object of the present disclosure is to provide a secondary battery having excellent operating characteristics and lifetime characteristics by comprising the electrode described above.

In order to achieve the above objects, the present disclosure provides an electrode for a secondary battery comprising a dry electrode film comprising an active material having an average particle diameter of 0.05 μm to 3 μm, an electrically conductive material, and a fibrillated binder; and a current collector on which the electrode film is stacked.
In addition, the present disclosure provides a method for manufacturing an electrode for a secondary battery comprising the steps of,
(a) mixing an active material having an average particle diameter of 0.05 μm to 3 μm, an electrically conductive material, and a fibrillable binder;
(b) performing shear mixing on the mixture to fiberize the fibrillable binder and thus to prepare a dry dough for the electrode;
(c) pulverizing the dry dough for the electrode to prepare a powder state;
(d) molding the powder in the form of a free-standing film by pressing the powder; and
(e) stacking the free-standing film on a current collector.

In addition, the present disclosure provides a secondary battery comprising the electrode.

The electrode for the secondary battery of the present disclosure provides excellent quality by comprising a dry electrode film that has excellent flexibility and minimizes the occurrence of breakage while comprising an active material with a small particle size,

In addition, the method for manufacturing the electrode for the secondary battery of the present disclosure provides an effect of greatly improving the manufacturing efficiency of the electrode.

In addition, the secondary battery of the present disclosure provides very excellent operating characteristics and lifetime characteristics by comprising the electrode.

### BRIEF DESCRIPTION OF DRAWINGS

FIG. 1 is a photograph image of the shape of the fibrillated binder comprised in the electrode according to an embodiment of the present disclosure.

FIG. 2 is a diagram schematically showing the structure of a free-standing film manufactured depending on the particle size of the active material.

FIG. 3 is a diagram schematically showing the manufacturing form of a free-standing film when one type of fibrillable binder is used as according to an embodiment of the present disclosure.

FIG. 4 is a diagram schematically illustrating a manufacturing form of a free-standing film when two or more types of fibrillable binders having different glass transition temperatures are used as according to an embodiment of the present disclosure.

FIG. 5 is a photograph image of the form of the free-standing film manufactured in Example 1 according to an embodiment of the present disclosure.

### DETAILED DESCRIPTION

Hereinafter, embodiments of the present disclosure will be described in detail with reference to the accompanying drawings so that those of ordinary skill in the art to which the present disclosure pertains can easily carry out the present disclosure. However, the present disclosure may be embodied in various different forms and is not limited to the embodiments described herein.

When the expression “stacked or disposed on the upper part or the lower part of a component” is mentioned to describe the relationship between components, it should be understood that although it may be directly stacked or disposed on the other components, other components may exist in therebetween.

The electrode for the secondary battery of the present disclosure comprises a dry electrode film comprising an active material having an average particle diameter of 0.05 μm to 3 μm, an electrically conductive material, and a fibrillated binder; and a current collector on which the electrode film is stacked.

As the particle size of the active material comprised in the electrode is smaller, since the degree of integration of the active material in the electrode is increased and thus the load amount of the active material per unit volume is increased, the energy density is increased and thus it is advantageous in terms of the capacity of the battery. Therefore, there is a need to use an active material having a small particle size in the manufacture of the electrode.

However, if the active material having an average particle diameter of 3 μm or less is used for the production of a dry electrode film, dough for manufacturing the electrode becomes too hard, and thus it is very difficult to process it in the form of a film, and even if it is possible to manufacture by applying high pressure, there is a problem that the prepared electrode film lacks flexibility and thus is easily broken. Therefore, according to the prior art, it is almost impossible to manufacture the dry electrode film, which is manufactured using active materials with a diameter of less than 3 μm. In addition, in the case of the active material having an average particle diameter of less than 0.05 μm, it is difficult to handle and expensive, and thus it is difficult to apply to the present disclosure.

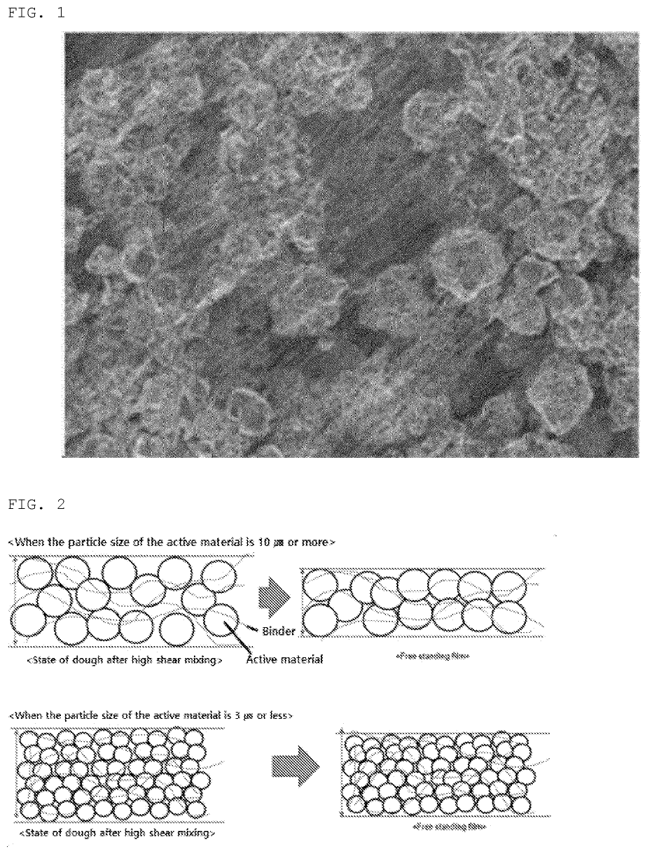

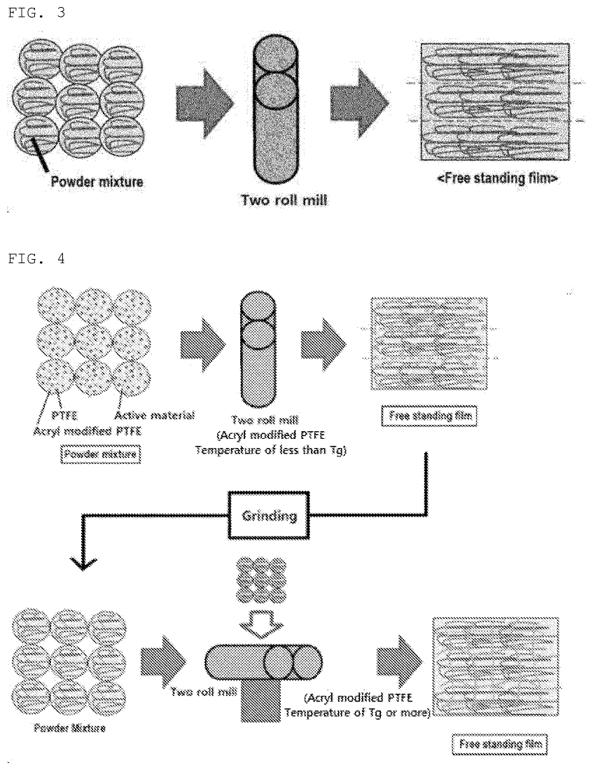

The fundamental reason why it is difficult to use the active material with a small size as described above seems to be that when performing high-shear mixing, the bonding properties between the particles are increased, and thus the dough is easily hardened, and the free space that can deform the shape is reduced as the internal pores are reduced, as shown in FIG. 2. In addition, the reason seems to be that as the size of the active material is decreased, the contact area between the active materials is increased, and accordingly, the dough hardens easily, and the pressure for forming into a film is increased beyond the limit of the equipment.

In the present disclosure, the electrode as described above was prepared for the first time by solving the manufacturing difficulties as described above. The electrode prepared in the present disclosure provides the effect of improving the operating characteristics and lifetime characteristics of the battery.

In the present disclosure, an average particle diameter of the active material may be set based on D50.

The electrode for the secondary battery of the present disclosure may be a positive electrode or a negative electrode.

In one embodiment of the present disclosure, the fibrillated binder may comprise polytetrafluoroethylene.

In one embodiment of the present disclosure, the fibrillated binder may further comprise acrylic-modified polytetrafluoroethylene. The acrylic-modified polytetrafluoroethylene refers to a binder in which the properties of polytetrafluoroethylene are modified by mixing an acrylic polymer with polytetrafluoroethylene. The acrylic-modified polytetrafluoroethylene can perform a function of improving the strength and flexibility of the free-standing film because the acrylic binder provides excellent adhesive properties above the glass transition temperature. In the above, polytetrafluoroethylene and the acrylic polymer may be mixed in a weight ratio of 7:3 to 3:7, preferably 6:4 to 4:6.

The polytetrafluoroethylene contained in the acrylic-modified polytetrafluoroethylene is a polymer capable of fibrillation, and for example, may be polytetrafluoroethylene having a high molecular weight, which has a melt viscosity of 108 poises or more at 380° C. In addition, when expressed as a standard specific gravity (ASTM D-1457), it may have a standard specific gravity of 2.210 or less, preferably 2.200 to 2.130.

The acrylic polymer may be, for example, a hydrocarbon-based monomer that is liquid at room temperature, and may be α,β-ethylenically unsaturated carboxylic acid esters such as methyl acrylate, methyl methacrylate, ethyl acrylate, ethyl methacrylate, n-propyl acrylate, n-propyl methacrylate, isopropyl acrylate, isopropyl methacrylate, lauryl acrylate and stearyl acrylate; hydroxyalkyl esters of α,β-ethylenically unsaturated carboxylic acids such as 2-hydroxyethyl acrylate, 2-hydroxyethyl methacrylate and 3-hydroxypropyl methacrylate; alkoxyalkyl esters of α,β-ethylenically unsaturated carboxylic acids such as diethylene glycol methacrylate; α,β-ethylenically unsaturated carboxylic acid amides such as acrylamide and methylol methacrylamide; α,β-ethylenically unsaturated carboxylic acids such as acrylic acid, methacrylic acid, itaconic acid, maleic anhydride, maleic acid, fumaric acid, and crotonic acid; acrylonitrile, etc, and one or more selected from these may be used.

The acrylic modified polytetrafluoroethylene may be used, for example, in the form of a powder, and specifically, Metabrene A-3000 manufactured by Mitsubishi Rayon company may be used. The structure of the powder may exist, for example, in the form of a matrix formed by mixing polytetrafluoroethylene and an acrylic polymer, or may have a structure formed by coating an acrylic polymer on polyterafluoroethylene.

The acrylic-modified polytetrafluoroethylene having a glass transition temperature exceeding 60° C. may be used.

In one embodiment of the present disclosure, the fibrillated binder may comprise polytetrafluoroethylene and the acrylic-modified polytetrafluoroethylene in a weight ratio of 1:9 to 9:1, preferably 3:7 to 7:3.

In one embodiment of the present disclosure, the average particle diameter of the active material may be 0.05 μm to 2 μm, and 0.05 μm to 1.5 μm.

In one embodiment of the present disclosure, the dry electrode film may comprise fibers fibrillated in multiple directions by the production of the dry dough for the electrode by the primary fibrillation of the fibrillable binder; pulverization by grinding of the dry dough for the electrode; and secondary fibrillation of the fibrillable binder during the forming of the dry electrode film by pressurizing the powder.

In addition, the method for manufacturing the electrode for the secondary battery of the present disclosure is characterized in that it comprises the following steps:
(a) mixing an active material having an average particle diameter of 0.05 μm to 3 μm, an electrically conductive material, and a fibrillable binder;
(b) performing shear mixing on the mixture to fiberize the fibrillable binder and thus to prepare a dry dough for the electrode;
(c) pulverizing the dry dough for the electrode to prepare a powder state;
(d) molding the powder in the form of a free-standing film by pressing the powder; and
(e) stacking the free-standing film on a current collector.

All of the above-described electrode-related contents may be applied to the manufacturing method. Therefore, descriptions of overlapping contents will be omitted.

The powder in the powder preparation step (c) may have a particle diameter of 100 μm to 1000 μm, more preferably 300 μm to 1000 μm. If the particle diameter of the powder is less than 100 μm, it is not preferable because there are difficulties in the process and the effect thereof is also limited. If the particle diameter of the powder exceeds 1000 μm, it is not preferable because it may cause difficulties in forming a uniform thickness and rolling density when manufacturing in the form of a film.

In the present disclosure, the fibrillable binder means a binder that can be made into fibers by the addition of shearing force.

In one embodiment of the present disclosure, the fibrillable binder may comprise polytetrafluoroethylene.

In one embodiment of the present disclosure, the fibrillable binder may further comprise acrylic-modified polytetrafluoroethylene.

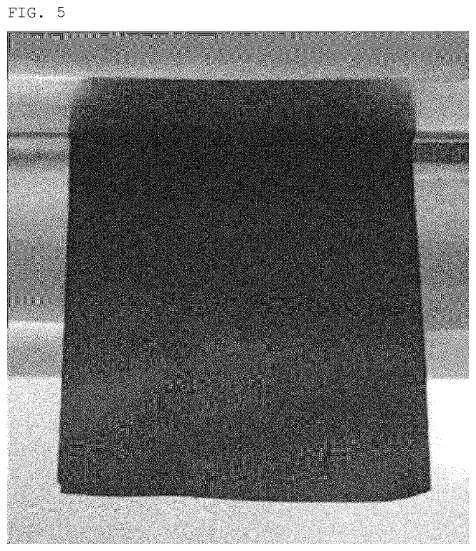

The acrylic modified polytetrafluoroethylene may have a glass transition temperature above 60° C. If the glass transition temperature is lower than the described temperature, the acrylic-modified polytetrafluoroethylene is fiberized in the dough preparation step (b), and subsequently, in the powder manufacturing step (c), the dry dough for the electrode is pulverized to a powder state, and thus the meaning of additionally adding acrylic-modified polytetrafluoroethylene is halved. That is, in one embodiment of the present disclosure, it is preferable that the acrylic-modified polytetrafluoroethylene is not fiberized in the dough preparation step (b) due to the glass transition temperature, but is fiberized in the film forming step (d), as shown in FIG. 4. According to this mechanism, the dry electrode film manufactured by the present disclosure can be manufactured to have high strength in both the MD (Machine Direction) direction and the TD (Transverse Direction) direction. Furthermore, the dry electrode film prepared by the present disclosure may have a form in which the fibrillable binder is fiberized in multiple directions.

In one embodiment of the present disclosure, the dough preparation step (b) may be performed at the glass transition temperature or at a temperature higher than the glass transition temperature of polytetrafluoroethylene, and specifically may be carried out in the range of 30 to 60° C. In this case, the upper limit of the temperature is preferably lower than the glass transition temperature of the acrylic-modified polytetrafluoroethylene.

In addition, the film forming step (d) may be performed at the glass transition temperature or at a temperature higher than the glass transition temperature of the acrylic-modified polytetrafluoroethylene, and specifically may be carried out in the range of exceeding 60 to 120° C.

In one embodiment of the present disclosure, the fibrillable binder may comprise polytetrafluoroethylene and the acrylic-modified polytetrafluoroethylene in a weight ratio of 1:9 to 9:1, preferably 3:7 to 7:3. When comprised in the above-mentioned range, the dry electrode film to be manufactured may have high strength in both the MD (Machine Direction) direction and the TD (Transverse Direction) direction, and furthermore, it is preferable because it can be fiberized in multiple directions and thus can have high strength in all directions.

In addition, the present disclosure provides a secondary battery comprising the electrode of the present disclosure.

The secondary battery may be a lithium secondary battery. Hereinafter, the content of the present disclosure described above will be described in more detail.

Active Material

As the active material, all of the components commonly used for the positive electrode and the negative electrode may be used. Specifically, for example, if the active material is a positive electrode active material, it may be particles of any one active material selected from the group consisting of LiCoO₂, LiNiO₂, LiMn₂O₄, LiCoPO₄, LiFePO₄ and LiNi1-x-y-zCoxM1yM2zO₂ (wherein M1 and M2 are each independently any one selected from the group consisting of Al, Ni, Co, Fe, Mn, V, Cr, Ti, W, Ta, Mg and Mo, and x, y and z are, independently of each other, the atomic fractions of the elements of the oxide composition and 0≤x<0.5, 0≤y<0.5, 0≤z<0.5, 0<x+y+z≤1), or a mixture of two or more thereof.

In addition, if the electrode active material is a negative electrode active material, it may be any one active material selected from the group consisting of carbonaceous material such as natural graphite or artificial graphite (mesophase carbon microbeads (MCMB, pyrolytic carbon, liquid crystal pitch-based carbon fiber (mesophase pitch-based carbon fiber), liquid crystal pitches (mesophase pitches), petroleum or coal tar pitch derived cokes, etc.); lithium-containing titanium composite oxide (LTO), metals (Me) which are Si, Sn, Li, Zn, Mg, Cd, Ce, Ni or Fe; alloys composed of the above-described metals (Me); oxides of the above-described metals (Me) (MeOx, for example: SIO); and a composite of the above-described metals (Me) and carbon, or a mixture of two or more thereof.

The active material may be contained, for example, in an amount of 85 to 98% by weight based on the total weight of the electrode film.

Electrically Conductive Material

In one embodiment of the present disclosure, the electrically conductive material is not particularly limited as long as it has conductivity without causing chemical change in the secondary battery. For example, it may be at least one selected from the group consisting of carbon black such as carbon black, acetylene black, Ketjen black, channel black, furnace black, lamp black, thermal black, etc.; metal powders such as aluminum and nickel powder; electrically conductive whiskers such as zinc oxide and potassium titanate; electrically conductive oxides such as titanium oxide; polyphenylene derivatives.

The electrically conductive material may be contained, for example, in an amount of 1 to 10% by weight, specifically 2 to 4% by weight, based on the total weight of the electrode film.

Binder

The present disclosure may further comprise other binders in addition to the fibrillated binder or fibrillable binder. The other binder is a component that assists bonding between the active material and the electrically conductive materials or adhesion to the current collector, and may be used without limitation as long as it is a material that can be used for the electrode. Specifically, the binder may be a non-acrylic polymer or an acrylic polymer.

The acrylic polymer is not limited as long as it is a polymer in which at least one repeating unit of the binder polymer is derived from an acrylic monomer. The acrylic monomer may be an alkyl acrylate, an alkyl methacrylate, an isoalkyl (meth) acrylate, and in this case, “alkyl” may be an alkyl group having 1 to 10 carbon atoms, and more specifically, an alkyl group having 1 to 5 carbon atoms.

Specific examples of the acrylic monomer may comprise methyl (meth)acrylate, ethyl (meth)acrylate, propyl (meth)acrylate, butyl (meth) acrylate, and pentyl (meth) acrylate.

The acrylic polymer may be a homopolymer composed of one repeating unit derived from an acrylic monomer, a copolymer including repeating units derived from two or more acrylic monomers, or a mixture of two or more thereof.

In addition, the acrylic polymer may be a copolymer of at least one non-acrylic monomer and an acrylate monomer, such as at least one selected from the group consisting of acrylate-styrene-butadiene rubber, acrylate-acrylonitrile-styrene-butadiene rubber, methyl acrylate-styrene-butadiene rubber, methyl acrylate-acrylonitrile-styrene-butadiene rubber, ethyl acrylate-styrene-butadiene rubber, ethyl acrylate-acrylonitrile-styrene-butadiene rubber, propyl acrylate-styrene-butadiene rubber, propyl acrylate-acrylonitrile-styrene-butadiene rubber, butyl acrylate-styrene-butadiene rubber, and butyl acrylate-acrylonitrile-styrene-butadiene rubber. In the case of a copolymer of a non-acrylic monomer and an acrylate monomer, the weight % of the repeating unit derived from the acrylate monomer may be 5 to 45% by weight, specifically 5 to 35% by weight.

In addition, the acrylic polymer may be a mixture of two or more types of homoacrylic polymers, a mixture of two or more types of acrylic copolymers, or a mixture two or more types of copolymers of non-acrylic monomers and acrylate monomers, and also, may be a mixture of two or more of a homoacrylic polymer, an acrylic copolymer, and a copolymer of a non-acrylic monomer and an acrylate monomer.

The non-acrylic polymer means a polymer comprising at least one repeating unit derived from a non-acrylic monomer, and specifically, may be a homopolymer composed of one type of repeating unit, a copolymer including two or more different types of repeating units, a mixture of two or more different types of homopolymers, or a mixture of two or more thereof.

Specific examples of the non-acrylic polymer may be one from the group consisting of styrene-butadiene rubber (SBR), a mixture of polystyrene and polybutadiene, polyvinylidene fluoride (PVDF), polyvinylidene fluoride-cohexafluoropropylene, polyvinylidene fluoride-cotrichloroethylene, polytetrafluoroethylene (PTFE), polyvinylpyrrolidone, polyethylene oxide, polyarylate, cellulose acetate, cellulose acetate butyrate, cellulose acetate propionate, cyanoethylpullulan, cyanoethyl polyvinyl alcohol, cyanoethyl cellulose), cyanoethyl sucrose, pullulan, and carboxyl methyl cellulose (CMC) or a mixture of two or more thereof. Among them, polyvinylidene fluoride (PVDF), polyethylene oxide (PEO), etc. may be preferably used.

In one embodiment of the present disclosure, the total binder content including the fibrillated binder may be 0.1 to 10% by weight, specifically, 1 to 4% by weight based on the total weight of the electrode film. When the content of the binder satisfies this range, the adhesive strength between the electrode active material layer and the current collector can be improved, the resistance of the electrode can be reduced or the detachment of the electrode can be prevented even after the degradation of the cell by improving adhesive strength, and the migration of the binder to the surface of the electrode can be suppressed, and thus the ionic conductivity or electrical conductivity in the electrode can be improved.

Current Collector

As the current collector, a known current collector used in secondary batteries may be used without limitation. For example, stainless steel, aluminum, nickel, titanium, carbon, copper; stainless steel surface-treated with carbon, nickel, titanium or silver; aluminum-cadmium alloy; a non-conductive polymer surface-treated with an electrically conductive material; a non-conductive polymer surface-treated with metal; a conductive polymer and the like may be used.

Manufacture of Electrode

Hereinafter, a method of manufacturing the electrode for the secondary battery of the present disclosure will be described by way of example.

The method for manufacturing the electrode for the secondary battery according to an embodiment of the present disclosure may comprise the following steps:
(a) mixing an active material having an average particle diameter of 0.05 μm to 3 μm, an electrically conductive material, and a fibrillable binder;
(b) performing shear mixing on the mixture to fiberize the fibrillable binder and thus to prepare a dry dough for the electrode;
(c) pulverizing the dry dough for the electrode to prepare a powder state;
(d) molding the powder in the form of a free-standing film by pressing the powder; and
(e) stacking the free-standing film on a current collector.

The mixing of step (a) means mixing in the absence of a solvent. The dry mixing may be performed by mixing at 600 rpm to 20000 rpm, more specifically, 1000 rpm to 12000 rpm, for 0.5 to 10 minutes at room temperature or lower using a stirring device.

The shear mixing of step (b) may comprise applying a high shearing force by shear compressing the mixture. Specifically, when using a device for applying a shearing force, for example, PBV-0.1L (Irie Shokai company), the high shearing force may be applied by shearing and compressing the mixture at 10 rpm to 100 rpm for 1 minute to 10 minutes. However, it is not necessarily limited to such a method.

The high shearing force may be 50N to 1000N, specifically 100N to 500N, and more specifically 100N to 300N.

In step (c), the powder may have a particle diameter of 100 μm to 1000 μm.

In the step of forming the free-standing film of step (d), the pressurization may be performed using a Two roll mill MR-3 (Inoue company).

Step (e) of stacking the free-standing film on the current collector may comprise a step of placing the free-standing film on a current collector and rolling them, and the rolling may be performed through a roll press method.

Manufacture of Secondary Battery

In addition, the present disclosure relates to a secondary battery comprising a positive electrode, a negative electrode, and a separator interposed between the positive electrode and the negative electrode, wherein at least one of the positive electrode and negative electrode is the aforementioned electrode. When the electrode according to the present disclosure is used only as any one of the positive electrode and negative electrode, the other electrode may be any one of electrodes known in the art without limitation.

Hereinafter, the secondary battery will be described as an example. Specifically, a lithium secondary battery will be described as an example.

As the separator, a porous polymer film commonly used as a separator in a lithium secondary battery, for example, a porous polymer film made of a polyolefin-based polymer such as ethylene homopolymer, propylene homopolymer, ethylene/butene copolymer, ethylene/hexene copolymer, and ethylene/methacrylate copolymer may be used alone or may be laminated and used. In addition, an insulating thin film having high ion permeability and mechanical strength may be used. The separator may comprise a safety reinforced separator (SRS) having an organic/inorganic composite porous coating layer coated thinly by connecting and fixing inorganic particles to the surface of a separator substrate such as a porous polymer film through a binder polymer. In addition, a conventional porous nonwoven fabric, for example, a nonwoven fabric made of glass fiber having a high melting point, polyethylene terephthalate fiber, etc. may be used, and a form in which the porous coating layer of the above-described organic/inorganic composite is applied even on the porous nonwoven fabric is also possible, but is not limited thereto.

The lithium secondary battery of the present disclosure can be manufactured by accommodating the assembly of the positive electrode and the negative electrode in a battery case and injecting electrolyte.

The electrolyte may comprise a lithium salt and an organic solvent for dissolving it. The lithium salt may be used without limitation as long as it is commonly used in electrolytes for secondary batteries, and for example, the anion of the lithium salt may be at least one selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)_{2N}.

The organic solvent comprised in the electrolyte may be used without limitation as long as it is used in this field, and representatively, may be at least one selected from the group consisting of propylene carbonate, ethylene carbonate, diethyl carbonate, dimethyl carbonate, ethylmethyl carbonate, methylpropyl carbonate, dipropyl carbonate, dimethyl sulfoxide, acetonitrile, dimethoxyethane, diethoxyethane, vinylene carbonate, sulfolane, gamma-butyrolactone, propylenesulfite and tetrahydrofuran.

In particular, among the carbonate-based organic solvents, ethylene carbonate and propylene carbonate, which are cyclic carbonates, are highly viscous organic solvents and have a high dielectric constant, so they can well dissociate lithium salts in the electrolyte, and thus can be used preferably. If a linear carbonate having a low viscosity and a low dielectric constant, such as dimethyl carbonate and diethyl carbonate, is mixed in an appropriate ratio with the cyclic carbonate, an electrolyte having a high electrical conductivity can be prepared, and thus can be used more preferably.

Optionally, the electrolyte stored according to the present disclosure may further comprise an additive such as an overcharging inhibitor comprised in a conventional electrolyte solution.

A known solid electrolyte may be used as the electrolyte.

The secondary battery according to an embodiment of the present disclosure may be a stack type, a wound type, a stack and fold type, or a cable type. In addition, the secondary battery may be used not only in a battery cell used as a power source for a small device, but also as a unit cell in a medium or large-sized battery module comprising a plurality of battery cells. Preferred examples of the medium or large-sized device may comprise electric vehicles, hybrid electric vehicles, plug-in hybrid electric vehicles, and power storage systems, and in particular, the secondary battery can be usefully used in hybrid electric vehicles and batteries for storing new and renewable energy, which are areas requiring high output.

With respect to the construction and manufacturing method of the secondary battery of the present disclosure, for parts not described above, the construction and manufacturing method known in the art may be applied without limitation.

Hereinafter, the present disclosure will be described in detail with reference to examples in order to specifically describe the present disclosure. However, the embodiments according to the present disclosure may be modified in various other forms, and the scope of the present disclosure should not be construed as being limited to the embodiments described below. Examples of the present disclosure are provided in order to more completely explain the present disclosure to those of ordinary skill in the art.

### Example 1: Manufacture of Positive Electrode

96 g of LFP powder (product name: DY-3, Dynanonic company), which is a particle of positive electrode active material with an average particle diameter of 1.08 μm, 2 g of Li250 (Denka company) as an electrically conductive material and 1 g of PTFE and 1 g of acryl modified PTFE (product name: A3800, Mitsubishi company) as a binder were mixed at 5000 rpm for 1 minute without solvent using Lab Blender (Waring company) as a blender (first mixing). Next, high shear mixing was performed by applying a shearing force of 250N to the mixture (PBV-0.1L, Irie Shokai company) at the temperature of 50° C. (second mixing). Next, the secondary mixture in the form of a dough was pulverized using a grinder (trade name: ZM200, Retsch company) and sieved to prepare a powder mixture having a particle size of 300 μm to 1000 μm. The mixture in the powder state was pressurized (Two roll mill MR-3, Inoue company) to prepare a free-standing film. At this time, the temperature of the roll of the Two roll mill MR-3 was set to 70° C. and sheeting was performed. Thereafter, the free-standing film was placed on one side of an aluminum current collector having a thickness of 15 μm, and pressurized to prepare a positive electrode.

### Comparative Example 1: Manufacture of Positive Electrode

The manufacturing process into a free-standing film was carried out by pressing (Two roll mill MR-3, Inoue company) the secondary mixture in the form of dough in Example 1, without the process of grinding and sieving to prepare the mixture in a powder state.

However, the secondary mixture was too hard to obtain a free-standing film, and thus it was also impossible to perform the electrode manufacturing process thereafter.

### Comparative Example 2: Manufacture of Positive Electrode

A positive electrode was manufactured in the same way as in Example 1, except that in Example 1, only “2 g of PTFE” is used as a binder instead of “1 g of PTFE and 1 g of acrylic modified PTFE.”

### Comparative Example 3: Manufacture of Positive Electrode

A positive electrode was manufactured in the same way as in Example 1, except that in Example 1, the secondary mixing is carried out at 100° C.

### Experimental Example 1: Observation of the Shape of Free-Standing Film (Dry Electrode Film)

(1) Evaluation of Appearance of Free-Standing Film

The shapes of the free-standing films prepared in Example 1, Comparative Example 2, and Comparative Example 3 were visually checked and photographed, and the results are shown in FIG. 5.

As can be seen in FIG. 5, in the case of the free-standing film of Example 1 of the present disclosure, breakage of the edge was not observed, but in the case of the free-standing films of Comparative Example 2 and Comparative Example 3, cracked edges were observed in some areas.

(2) Evaluation of Flexibility of Free-Standing Film

The flexibility of the free-standing films prepared in Example 1, Comparative Example 2, and Comparative Example 3 above was measured in the longitudinal and transverse directions respectively using a mandrel flexural evaluation tester apparatus (standard test specification: ISO 1519: 2011, ASTM D522, DIN 53152) by measuring the flexibility while gradually decreasing the diameter of the cylindrical device, and measuring the diameter at which cracking begins. The measurement results are shown in Table 1 below.

(3) Evaluation of Tensile Strength of Free-Standing Film

In order to measure the longitudinal and transverse tensile strength of the free-standing films prepared in Example 1, Comparative Example 2, and Comparative Example 3, electrodes having a width of 20 mm, a length of 200 mm, and a thickness of 200 μm were sampled. For the samples, tensile strength was measured at a condition of 50 mm/min by a 180 degree peel measurement method using Instron's UTM equipment. During the measurement, the maximum value of the force applied up to the point in time at which cracks did not occur on the film was evaluated as the strength of the free-standing film, and the measurement results are shown in Table 1 below.

TABLE 1

| | Flexibility | | | |
|---|---|---|---|---|
| | (diameter at which cracking | | | |
| | occurs, mm) | | Tensile strength | |
| | Longitudinal | Transverse | Longitudinal | Transverse |
| | direction | direction | direction | direction |
| Example 1 free- | 3 | 5 | 6.5 | 3.1 |
| standing film | | | | |
| Comparative | 3 | 25 | 6.2 | 0.7 |
| Example 2 | | | | |
| free-standing film | | | | |
| Comparative | 3 | 30 | 5.9 | 0.4 |
| Example 3 | | | | |
| free-standing film | | | | |

### Example 2 and Comparative Example 4: Manufacture of Lithium Secondary Battery

Batteries of Example 2 and Comparative Example 4 were prepared using the positive electrodes prepared in Example 1 and Comparative Example 3, respectively. A specific manufacturing method is as follows.

(1) Manufacture of Negative Electrode

Natural graphite as a negative electrode active material, carbon black which is an electrically conductive material, and a PVdF binder were mixed in an N-methylpyrrolidone solvent in a weight ratio of 85:10:5 to prepare a composition for forming a negative electrode, and the composition was applied to a copper current collector to prepare a negative electrode.

(2) Manufacture of Lithium Secondary Battery

A separator of porous polyethylene was interposed between the positive electrode prepared in Example 1 or Comparative Example 3, and the negative electrode prepared in (1) above to manufacture an electrode assembly, and the electrode assembly was placed inside the case, and then, the electrolyte was injected into the case to manufacture a lithium secondary battery. At this time, the electrolyte solution was prepared by dissolving lithium hexafluorophosphate (LiPF₆) at a concentration of 1.0M in an organic solvent consisting of ethylene carbonate/dimethyl carbonate/ethylmethyl carbonate (mixed volume ratio of EC/DMC/EMC=3/4/3). Through this, lithium secondary batteries of Example 2 and Comparative Example 4 were manufactured.

### Experimental Example 2: Evaluation of Capacity Retention Rate of Lithium Secondary Battery

The secondary batteries of Example 2 and Comparative Example 4 manufactured above were charged and discharged to evaluate the capacity retention rate, and the results are shown in Table 2 below. Cycles 1 and 2 were charged and discharged at 0.1C, and from cycle 3 to cycle 49, charging and discharging were performed at 0.5C. Cycle 50 ended in the charged state (lithium is in the negative electrode).
Charging conditions: CC (constant current)/CV (constant voltage) (4.25 mV/0.05C current cut-off)
Discharging condition: CC (constant current) condition 3.0V

The capacity retention rate was derived by the following calculations.

Capacity retention rate (%)=(discharging capacity at cycle49/discharging capacity at first cycle)×100

TABLE 2

| | Capacity retention rate (%) |
|---|---|
| Example 2 lithium secondary battery | 97.4 |
| Comparative Example 4 lithium | 97.0 |
| secondary battery | |

1. An electrode for a secondary battery, the electrode comprising:
a dry electrode film comprising an active material having an average particle diameter of 0.05 μm to 3 μm, an electrically conductive material, and a fibrillated binder; and
a current collector on which the dry electrode film is stacked.

2. The electrode according to claim 1, wherein the fibrillated binder comprises polytetrafluoroethylene.

3. The electrode according to claim 2, wherein the fibrillated binder further comprises acrylic-modified polytetrafluoroethylene.

4. The electrode according to claim 3, wherein the fibrillated binder comprises polytetrafluoroethylene and the acrylic-modified polytetrafluoroethylene in a weight ratio of 1:9 to 9:1.

5. The electrode according to claim 3, wherein the acrylic-modified polytetrafluoroethylene is formed by mixing polytetrafluoroethylene and an acrylic polymer in a weight ratio of 7:3 to 3:7.

6. The electrode according to claim 1, wherein an average particle diameter of the active material is 0.05 μm to 2 μm.

8. The electrode according to claim 1, wherein the dry electrode film comprises fibers fibrillated in multiple directions by the production of the dry dough for the electrode by the primary fibrillation of the fibrillable binder, pulverization by grinding of the dry dough for the electrode, and secondary fibrillation of the fibrillable binder during the forming of the dry electrode film by pressurizing the powder.

8. A method for manufacturing an electrode for a secondary battery comprising:
(a) mixing an active material having an average particle diameter of 0.05 μm to 3 μm, an electrically conductive material, and a fibrillable binder;
(b) performing shear mixing on the mixture to fiberize the fibrillable binder and thus to prepare a dry dough for the electrode;
(c) pulverizing the dry dough for the electrode to prepare a powder state;
(d) molding the powder in the form of a free-standing film by pressing the powder; and
(e) stacking the free-standing film on a current collector.

9. The method according to claim 8, wherein the powder in step (c) has a particle diameter of 100 μm to 1000 μm.

10. The method according to claim 8, wherein the fibrillable binder comprises polytetrafluoroethylene.

11. The method according to claim 10, wherein the fibrillable binder further comprises acrylic-modified polytetrafluoroethylene.

12. The method according to claim 11, wherein the fibrillable binder comprises polytetrafluoroethylene and the acrylic-modified polytetrafluoroethylene in a weight ratio of 1:9 to 9:1.

13. The method according to claim 11, wherein the acrylic-modified polytetrafluoroethylene is formed by mixing polytetrafluoroethylene and an acrylic polymer in a weight ratio of 7:3 to 3:7.

14. The method according to claim 11, wherein step (b) is performed at the glass transition temperature of polytetrafluoroethylene or at a temperature higher than the glass transition temperature of polytetrafluoroethylene and lower than the glass transition temperature of acrylic-modified polytetrafluoroethylene, and step (d) is performed at the glass transition temperature of acrylic-modified polytetrafluoroethylene or at a temperature higher than the glass transition temperature of acrylic-modified polytetrafluoroethylene.

15. A secondary battery comprising the electrode of claim 1.
